(19) United States
(12) Patent Application Publication
(10) Pub. No.: US 2009/0119062 A1
(43) Pub. Date: May 7, 2009

(54) Time Tracking Methods and Systems

(75) Inventors: Brett M. OWENS, Sacramento, CA (US); Chihab BAHHADI, Brussels (BE)

Correspondence Address: KRUEGER ISELIN LLP (SC), P O BOX 1906, CYPRESS, TX, 77410-1906, US

(73) Assignee: TimeTracking Buddy LLC, Sacramento, CA (US)

(21) Appl. No.: 12/167,181

(22) Filed: Jul. 2, 2008

Related U.S. Application Data
(60) Provisional application No. 61/001,356, filed on Nov. 1, 2007.

(51) Int. Cl. G06F 15/00; G04F 10/00

(52) U.S. Cl. 702/176; 702/187

(57) ABSTRACT

Time tracking methods and systems are disclosed. In some embodiments, a method for tracking a subject's use of time includes recording, at timed intervals, time tracking data indicative of a work effort being accessed by the subject. The time tracking data, along with link data associating one or more accounts with corresponding work efforts, is analyzed to attribute a portion of the subject's time to an account. A report is generated in which the portion of the subject's time is attributed to the account. The subject may be, for example, a computer system user. The work efforts may each include, for example, a file, a folder, or a Universal Resource Locator. The link data may be created on a computer system using a drag-and-drop function. Computer systems are described including instructions for carrying out time tracking methods.

### CROSS-REFERENCE TO RELATED APPLICATIONS

This application claims priority to U.S. Provisional Patent Application Ser. No. 61/001,356, filed Nov. 1, 2007, entitled “TimeTracking Buddy—Software that automatically tracks, records, and reports how you spend time on your computer and/or handheld device” to Brett M. Owens and Chihab Bahhadi, which is hereby incorporated herein by reference in its entirety.

### BACKGROUND

In today's world, many tasks, such as document preparation, accounting, communication, and research, are often accomplished with the aid of specialized software running on computer systems. For example, an attorney working on behalf of a client may spend time preparing a document via word processing software running on a computer system. The attorney may also research a topic on the World Wide Web (Web) via Web browser software running on the computer system, or communicate with the client via electronic mail (email) client software running on the computer system. An accountant may spend time working on a spreadsheet via spreadsheet software running on a computer system. An engineering consultant may spend time designing a system via simulation software running on a computer system.

Many service professionals, such as attorneys, accountants, and consultants, often bill their clients for amounts of time the service professionals spend working on the clients' behalf. Such service professionals must track the amounts of time they work for their clients in order to complete timesheets and/or create billing statements.

Probably the oldest timekeeping method involves using pencil and paper to manually record time spent working on tasks. However, timekeepers often fail to record their work times regularly, resulting in inaccurate time keeping records.

Various computer software products for timekeeping and billing are available. Many of these software products require timekeepers to manually enter time spent on tasks, and to assign work times to specific clients. As they rely on timekeeper entries, such software products do little to improve timekeeping accuracy.

Some computer software products for timekeeping and billing include a stopwatch feature. In some systems, timekeepers can set up one or more stopwatches, each of which is associated with a particular task. The stopwatches may be displayed on a display screen of a computer system, and may be used by a timekeeper to track times spent on corresponding tasks. While the stopwatch feature may improve timekeeper accuracy, the feature itself is often time consuming to use. Before using the feature, the timekeeper typically must initiate software execution and enter task information for each active stopwatch.

Known time tracking systems and methods require timekeeper actions to produce accurate time keeping records. As timekeepers often fail to make these actions, it would be beneficial to have time tracking methods and systems capable of automatically tracking time spent by a subject on one or more tasks.

### SUMMARY

Disclosed herein are time tracking methods and systems that enable automatic tracking of time spent by a subject on one or more tasks for different potential uses (e.g., billing, productivity tracking, operations research). In some embodiments, a method for tracking a subject's use of time includes recording, at timed intervals, time tracking data indicative of a work effort being accessed by the subject. The time tracking data, along with link data associating one or more accounts with corresponding work efforts, is analyzed to attribute a portion of the subject's time to an account. A report is generated in which the portion of the subject's time is attributed to the account.

The subject may be, for example, a computer system user. The work efforts may each include, for example, a file, a folder, or a Universal Resource Locator. The method may also include linking one or more accounts with corresponding work efforts to generate the link data. The linking may be carried out on a computer system using a drag-and-drop function. The recording of the time tracking data may be performed on a first computer system, and the method may include transmitting the time tracking data to a second computer system. The analyzing of the time tracking data and the link data, and the generating of the report, may be performed on the second computer system.

In some embodiments, a method for tracking a subject's use of time includes establishing a link between at least one work effort and an account, thereby generating link data. At timed intervals, time tracking data is recorded, where the time tracking data is indicative of a work effort that is currently active on a computer system operated by the subject. The time tracking data and the link data are transmitted to a central server. A report is received from the central server and displayed, where the report attributes a portion of the subject's time to the account.

The time tracking data may be recorded in a log file. The recording may include querying an operating system of the computer system to obtain a title of a foreground window in which the subject is currently working. The recording may further include generating data indicative of a current time and the title of the foreground window, and storing the data in the log file.

In some embodiments, a method for tracking a subject's use of time includes receiving time tracking data and link data, where the time tracking data is indicative of work efforts active at timed intervals on a computer system operated by the subject, and where the link data associates one or more accounts with corresponding work efforts. The time tracking data and link data are analyzed, thereby attributing a portion of the subject's time to at least one of the one or more accounts. A report is generated in which the portion of the subject's time is attributed to the at least one of the one or more accounts, and the report is transmitted.

In some embodiments, a computer system includes a display screen, a memory, and at least one processor coupled to the memory. The memory contains instructions for: establishing a link between a work effort and an account, thereby generating link data; at timed intervals, recording time tracking data indicative of a work effort that is currently active on the computer system, wherein the computer system is operated by a user; transmitting the time tracking data and the link data; receiving a report wherein a portion of the user's time is attributed to the account; and displaying the report on the display screen. The at least one processor is configured to fetch the instructions from the memory and to execute the instructions.

In some embodiments, a computer system includes a display screen, a memory, and at least one processor coupled to the memory. The memory contains instructions for: receiving time tracking data and link data, wherein the time tracking data is indicative of work efforts accessed by a subject at timed intervals, and wherein the link data is indicative of a link established between a work effort and an account; analyzing the time tracking data and link data, thereby attributing a portion of the subject's time to the account; generating a report wherein the portion of the subject's time is attributed to the account; and transmitting the report. The at least one processor is configured to fetch the instructions from the memory and to execute the instructions.

### BRIEF DESCRIPTION OF THE DRAWINGS

A better understanding of the various disclosed embodiments can be obtained when the detailed description is considered in conjunction with the following drawings, in which:

FIG. 1 is a diagram of one embodiment a time tracking system including a server system and a client system coupled to a communication network;

FIG. 2 is a diagram of one embodiment of the server system of FIG. 1;

FIG. 3 is a diagram of one embodiment of the client system of FIG. 1;

FIG. 4 is a diagram of one embodiment of time tracking client software stored in a memory of the client system of FIG. 1;

FIG. 5 is a diagram of one embodiment of time tracking server software stored in a memory of the server system of FIG. 1;

FIGS. 6A and 6B in combination form a flowchart of one embodiment of a method for tracking a subject's use of time;

FIG. 7 is an image of an activity log page of an illustrative activity report as displayed on a display screen;

FIG. 8 is an image of a bar chart page of an illustrative activity report as displayed on a display screen; and

FIG. 9 is an image of a pie chart page of an illustrative activity report as displayed on a display screen.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

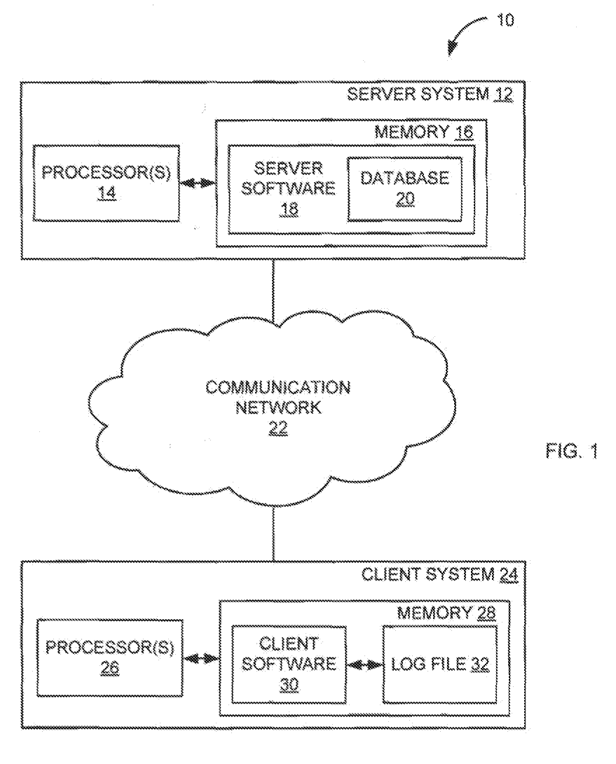

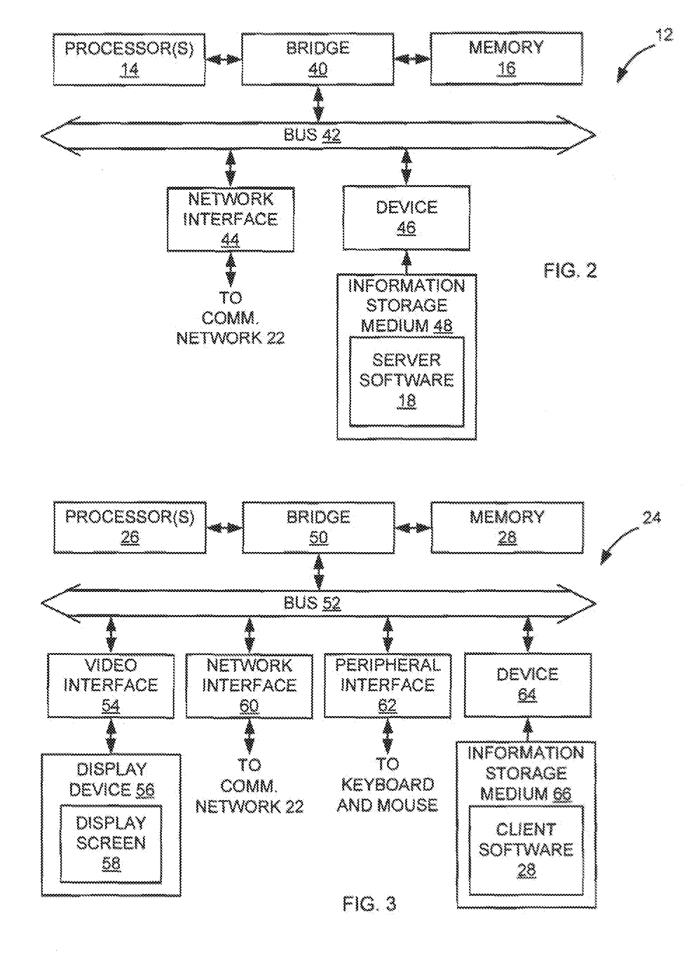

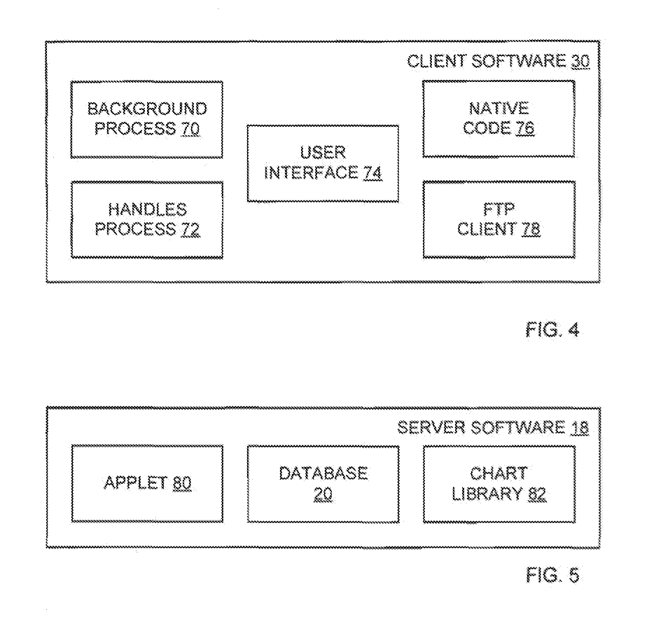

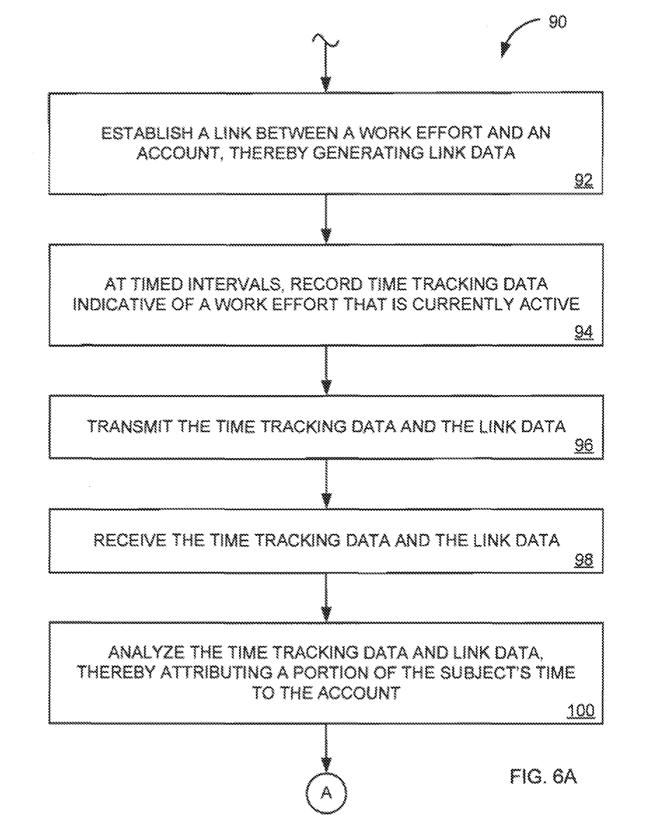

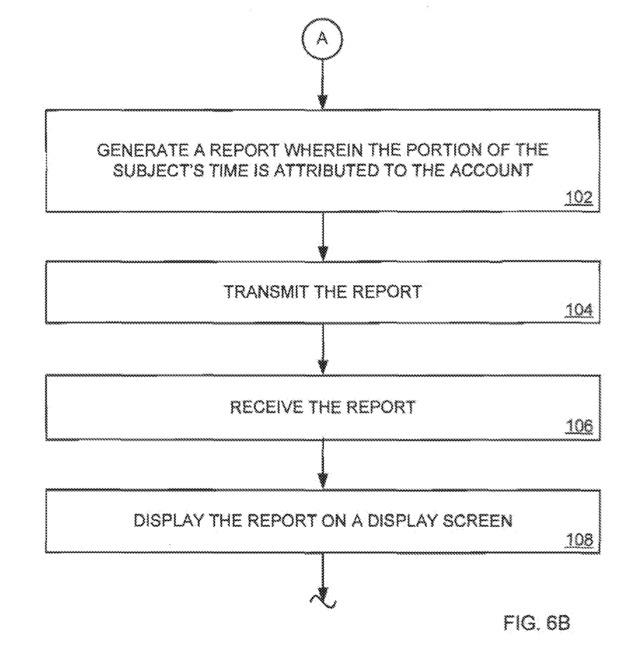

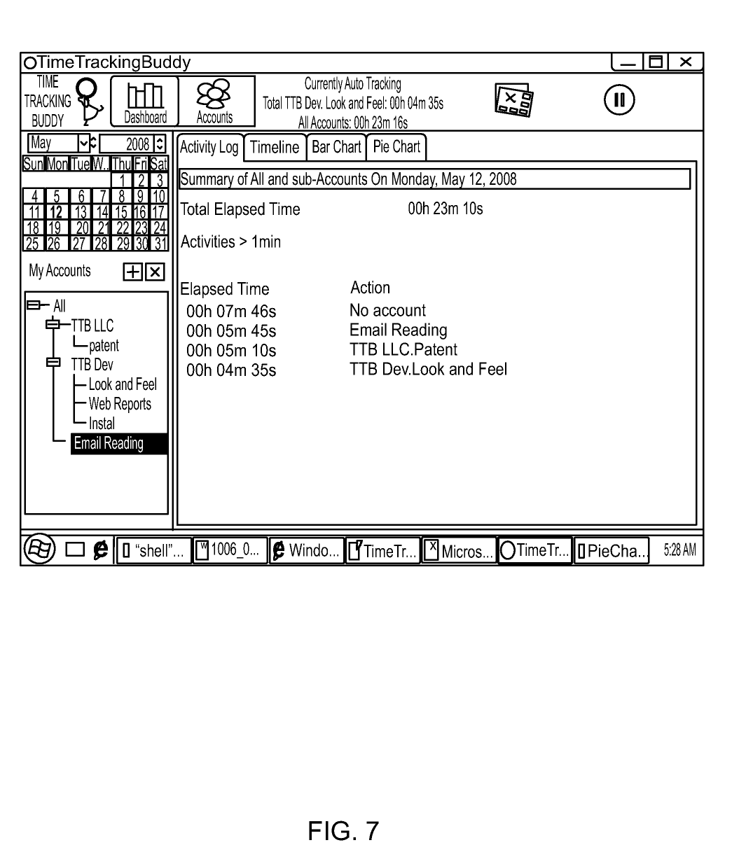

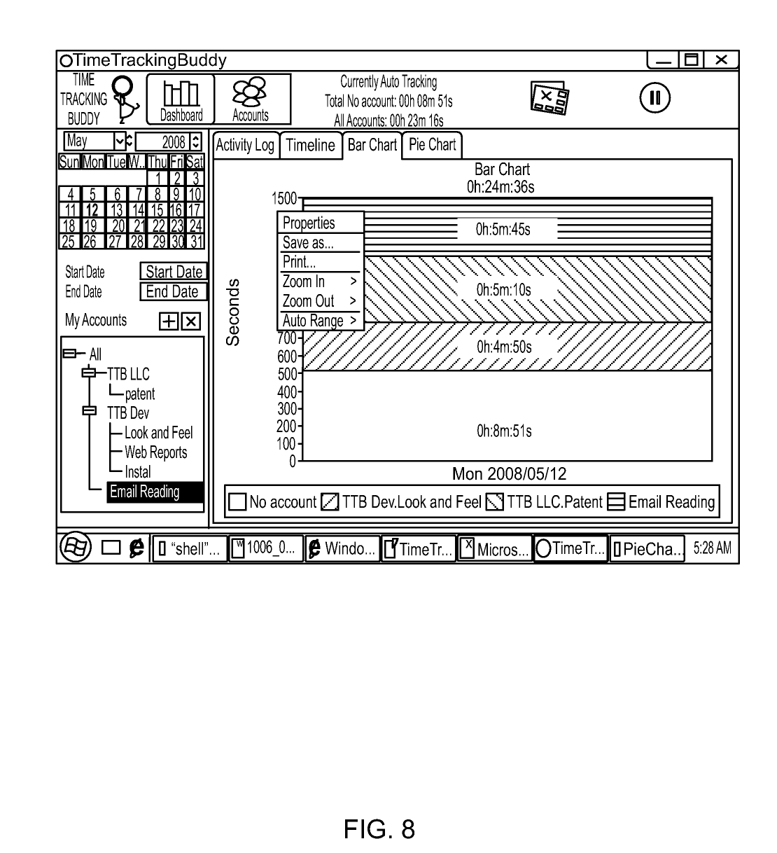

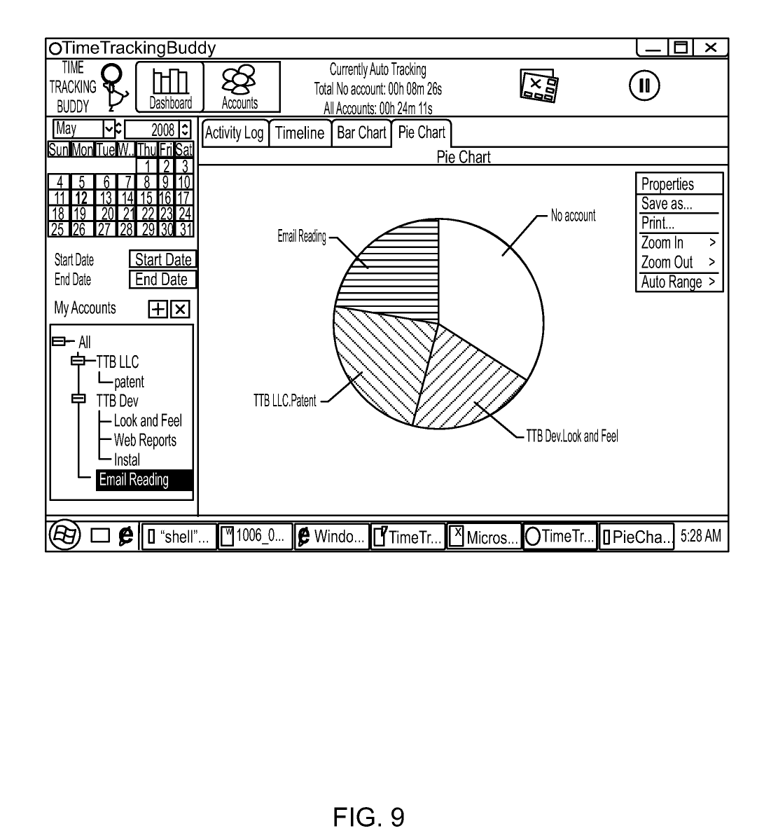

1. FIG. 1 is a diagram of one embodiment a time tracking system 10 including a server system 12 and a client system 24 coupled to a communication network 22. The server system 12 and the client system 24 communicate via the communication network 22. The communication network 22 preferably includes the Internet. In the embodiment of FIG. 1, the server system 12 includes one or more processor(s) 14 coupled to a memory 16. The one or more processor(s) 14 execute instructions stored in the memory 16. FIG. 1 indicates that server software 18 is stored in the memory 16. The memory 16 may include, for example, a persistent storage medium such as a hard disk, and the server software 18 may be stored on the storage medium. As described in more detail below, the server software 18 includes a database 20 for storing time tracking data and link data.
   a. In the embodiment of FIG. 1, the client system 24 includes one or more processor(s) 26 coupled to a memory 28. The one or more processor(s) 26 execute instructions stored in the memory 28. FIG. 1 indicates that client software 30 is stored in the memory 28, along with a log file 32. The memory 28 may include, for example, a persistent storage medium such as a hard disk, and the client software 30 and/or the log file 32 may be stored on the storage medium. As described in more detail below, the log file 32 is used to store time tracking data recorded at timed intervals and indicative of activities or work efforts of the user at the times the data was recorded.
   b. A user of the client system 24 of FIG. 1 is the subject of the time tracking efforts described herein. The client system 24 may be or include, for example, a computer system such as a desktop computer system, a laptop computer system, or a notebook computer system. Alternatively, the client system 24 may be or include a handheld computing system or device.
2. FIG. 2 is a diagram of one embodiment of the server system 12 of FIG. 1. In the embodiment of FIG. 2, the processor(s) 14 and the memory 16 of the server system 12 are coupled to a bridge 40. The processor(s) 14 access the memory 16 via the bridge 40, obtain instructions from the memory 16, and execute the instructions. The bridge 40 is coupled to a bus 42, and forms an interface to the bus 42. A network interface 44 is coupled to the bus 42. The processor(s) 14 send information to, and receive information from, the communication network 22 via the bridge 40, the bus 42, and the network interface 44.
3. An information storage device 46 is coupled to the bus 42, and adapted to receive an information storage medium 48 having the server software 18 stored thereon or therein. The information storage medium 48 may be, for example, a computer-readable storage medium. The server software 18 includes program instructions which, when executed by the processor(s) 14, cause the processor(s) 14 to carry out steps of a time tracking method. When the information storage medium 48 is inserted in the device 46, the program instructions of the server software 18 may be copied or transferred from the information storage medium 48 to the memory 16. The device 46 may be, for example, a floppy disk drive, and the information storage medium 48 may be a floppy disk. Alternatively, the device 46 may be a compact disk read only memory (CD-ROM) drive, and the information storage medium 48 may be a CD-ROM. Further still, the device 46 may be or include a universal serial bus (USB) port, and the information storage medium 48 may be a USB flash memory drive.
   a. FIG. 3 is a diagram of one embodiment of the client system 24 of FIG. 1. In the embodiment of FIG. 3, the processor(s) 26 and the memory 28 of the client system 24 are coupled to a bridge 50. The processor(s) 26 access the memory 28 via the bridge 50, obtain instructions from the memory 28, and execute the instructions. The bridge 50 is coupled to a bus 52, and forms an interface to the bus 52. A video interface 54 (e.g., a video card) is coupled to the bus 52, and to a display device 56. The display device 56 includes a display screen 58. The processor(s) 26 send information to, and receive information from, the display device 56 via the bridge 50, the bus 52, and the video interface 54.
4. A network interface 60 is coupled to the bus 52. The processor(s) 26 send information to, and receive information from, the communication network 22 via the bridge 50, the bus 52, and the network interface 60. A peripheral interface 62 is coupled to the bus 52, and to a keyboard and mouse of the client system 24. The processor(s) 26 receive information from, and send information to, the keyboard and the mouse via the bridge 50, the bus 52, and the peripheral interface 62.
5. An information storage device 64 is coupled to the bus 52, and adapted to receive an information storage medium 66 having the client software 30 stored thereon or therein. The information storage medium 66 may be, for example, a computer-readable medium. The client software 30 includes program instructions which, when executed by the processor(s) 26, cause the processor(s) 26 to carry out steps of a time tracking method. When the information storage medium 66 is inserted in the device 64, the program instructions of the client software 30 may be copied or transferred from the information storage medium 66 to the memory 28. The device 64 may be, for example, a floppy disk drive, and the information storage medium 66 may be a floppy disk. Alternatively, the device 64 may be a compact disk read only memory (CD-ROM) drive, and the information storage medium 66 may be a CD-ROM. Further still, the device 64 may be or include a universal serial bus (USB) port, and the information storage medium 66 may be a USB flash memory drive. In some embodiments, the client software 30 is downloaded from the server system 12 to the client system 24 via the communication network 22.
6. FIG. 4 is a diagram of one embodiment of the client software 30 of FIG. 1. In the embodiment of FIG. 4, the client software 30 includes a background process 70, a handles process 72, a user interface 74, a native code module 76, and a File Transfer Protocol (FTP) client 78. As described in more detail below, the client software 30 captures time tracking data relating to activities or work efforts of the user on the client system 24 of FIG. 1, stores the time tracking data in the log file 32 of FIG. 1, transfers the time tracking data to the server system 12 of FIG. 1, receives time tracking report information from the server system 12, and displays the time tracking report information on the display screen 58 of the display device 56 of the client system 24.
7. At least some of the system embodiments disclosed herein track “activities” or “Work efforts” carried out by the user of the client computer system 24. Each “activity” or “work effort” may be or include, for example, a file, a folder, a Universal Resource Locator (URL), an email message (with an email address used to determine the account), use of an application software program, or a telephone call (with a phone number used to determine the account).
8. In the following description, components of the client software 30 will be described as carrying out activities directly for the sake of clarity. It will be understood that the components include instructions that, when executed by the processor(s) 26 of the client system 24, cause the processor(s) 26 to carry out the activities.
9. In some embodiments, the background process 70 queries an operating system of the client system 24 at regular intervals for the title of the foreground window (the window in which the user is currently working). In some embodiments, background process 70 queries the operating system about every 5 seconds. The purpose of this querying is to determine if the foreground window has changed since the last query. An alternative to this querying is to have the operating system notify the client software 30 when the foreground window changes. This notification approach is, however, very platform dependent, and adapting computer code for different operating system is difficult.
10. In some embodiments, the client system 24 includes a Microsoft Windows® operating system (Microsoft Corp., Redmond, Wash.), and the background process 70 includes Java™ programming language instructions (Sun Microsystems, Inc., Menlo Park, Calif.). The background process 70 includes Java™ Native Interface (JNI) code. About every 5 seconds, the background process 70 uses the JNI code to query the Windows® operating system for the title of the foreground window (the window with which the user is currently working). In response to the query, the Windows® operating system returns the handle to the foreground window. For example, the Windows® operating system may include a Win32 Application Programming Interface (API) including a “GetForegroundWindow” function that returns the handle to the foreground window. Using the handle returned by the Windows® operating system, the JNI code retrieves the title and the associated process.
11. For example, assume the user is working on a Microsoft Word® document entitled “Presentation.doc.” When the JNI code queries the Windows® operating system, the Windows® operating system returns the handle to the foreground window. Using the handle, the JNI code retrieves the title “Presentation” and the associated process “WINWORD.EXE.”
12. The JNI code then queries the Windows® operating system for the last time the foreground window received an input from the user. The input may be from a keyboard or a mouse. For example, the Windows® operating system Win32 API may include a “GetLastInputInfo” function that returns the last input from the user.
13. Combining the last input information with the current time, the background process 70 generates a line of textual data that looks like this:
14. “Time of Activity; Process Name; Window Title; Time of Last Input Event”
15. where the ‘Time of Activity’ indicates the current time, the ‘Process Name’ indicates the name of the process, the ‘Window Title’ indicates the title of the foreground window, and the ‘Time of Last Input Event’ indicates the time the last input was received from the user. The above line of textual data is stored in the log file 32 of FIG. 1 as a log entry.
16. In some embodiments, the background process 70 includes a timeout mechanism. If the background process 70 detects no user action or activity on the client system 24 for a predetermined period of time, the background process 70 enters an end time for the current activity or work effort. In some embodiments, if the ‘Time of Last Input Event’ is greater than a parameter specified by the user (e.g., 5 minutes), the background process 70 stops updating the log file 32 of FIG. 1 every 5 seconds until the ‘Time of Last Input Event’ is again less than the parameter.
17. Since two Word® documents can have the same title, relying on the line of textual data may not be enough. For activities that are linked to physical files (e.g., working on a Microsoft Excel® document or a Microsoft PowerPoint® presentation) as opposed to activities that are linked to databases (e.g., an Oracle® database session) or to a Web page, the client software 30 determines the physical location of the document linked to the foreground window. Using this information, the client software 30 can distinguish between two files with the same name but stored in different locations.
18. In some embodiments, the handles process 72 queries the operating system of the client system 24 when the user is performing an activity or work effort linked to a file in order to determine the physical location of the file. (If, on the other hand, the user is using a Web browser application program, no physical file is being accessed to perform the activity or work effort, and no handles are needed.)
19. When the user is performing an activity or work effort linked to a physical file, the file may be stored in the memory 28 of the client system 24, or on another computer system accessible via the communication network 22. For example, if the user is editing a Microsoft Word® document on the client system 24, handles are needed to determine which physical file contains the document being modified by the Word® application program. Examples of application programs that require handles when executed on the client system 24 include: Microsoft Office® programs including Word®, PowerPoint®, and Excel® (Microsoft Corp., Redmond, Wash.), Adobe Acrobat® and Photoshop® software (Adobe Systems, Inc., San Jose, Calif.), OpenOffice.org programs, and the GNU Image Manipulation Program (GIMP) software.
20. In some embodiments, the handles process 72 includes a ‘ttb.exe’ program, and the client software 30 executes a command “call ttb.exe” in a separate process. Given a process name (PN) and a window title, the program ‘ttb.exe’ acts like the Unix ‘Isof’ command (list open files) and returns a list of all open files belonging to the process with the process name PN. For example, for the Word® document “Presentation.doc,” the program “ttb.exe” would provide the physical location of the file, e.g. “c:\my documents\Presentation.doc.”
21. The program “ttb.exe” uses ‘NtQuerySystemInformation’ to enumerate opened handles, filter the result using the property ‘ObjectType’ of the structure ‘_SYSTEM_HANDLE’ and get the object name using ‘NtQueryObject.’ The result is the process ID, the process name, and the file location.
22. The program “ttb.exe” provides an output stream, and the client software 30 reads the output stream. When the program “ttb.exe” is called to locate a physical file, instead of writing the title of the window to the log file “stats.ttb,” the client software 30 writes the path to the file to the log file “stats.ttb.”
23. In some embodiments, the user interface 74 includes instructions that, when executed by the processor(s) 26, cause the processor(s) 26 to allow the user to create accounts and subaccounts (real or virtual), link specific user activities to accounts (or subaccounts), and to display an activity log. In some embodiments, the user interface 74 allows the user to link specific activities to accounts (or subaccounts) via a drag-and-drop function. A typical drag-and-drop operation involves using the mouse to position a cursor on a displayed object to be moved (e.g., an icon representing a file or folder), pressing and holding down a button of the mouse to “grab” the object, “dragging” the object to a desired location, and “dropping” the object by releasing the mouse button. The user can also link documents to accounts (or subaccounts) via a directory navigation system in a manner similar to locating a document using Windows Explorer®. The user can link specific documents on the Web to accounts (or subaccounts) by assigning URLs of the documents to the account (e.g., via direct entry). The user can also link email addresses or phone numbers (which may be dialed or detected by software) to accounts (or subaccounts) via direct entry. Other user activities can be linked to accounts by using keyword logic, e-mail addresses, and/or voice recognition.
24. In some embodiments, the activity log is an image or page including information for displaying a summary of user activities or work efforts and the corresponding elapsed times. Via the user interface 74, the user sends a request for an activity log to the server system 12 (via the communication network 22). The server system 12 receives the request, generates the activity log on the fly (as described in more detail below), and sends the activity log to the client system 24 (via the communication network 22). The clients system 24 receives the activity log from the server system 12 of FIG. 1 and displays the activity log on the display screen 58 of the display device 56 of FIG. 3. The default activity log is a summary of user activities or work efforts for the current day sorted by elapsed time. The activity log will be described in more detail below. The server system 12 may also capable of displaying a summary of user actions or activities or work efforts on a display screen of the server system 12.
25. As described above, the client software 30 can also track Internet browsing activities. A browser window typically only gives a title of the Website, not the URL of the Website. The native code module 76 includes JNI code that retrieves the URL from the browser software.
26. In the Windows® environment, every window is composed of “children windows.” For the Microsoft Internet Explorer® Web browser, the browser windows include the content window, the address bar window, the menu window (with back and forth buttons), the AOL window, etc. The JNI code of the native code module 76 drills down to the address bar and retrieves the textual URL. The native code module 76 also queries the Windows® operating system to get the process version (i.e., the version number of the process PN). This is accomplished via a call to the Windows® registry.
27. In general, a line of textual data is created of the form:
28. “Time of Action; Process Name; URL; Time of Last Input Event; Version”
29. For an Internet Explorer(& activity or work effort, the line of textual data is of the form:
30. “Time of Action; IEXPLORE.EXE; URL; Time of Last Input Event; version (1.6.00.8)”
31. The above line of textual data is stored in the log file 32 of FIG. 1 as a log entry.
32. In some embodiments, the log file 32 of FIG. 1 contains the following information:
   i. Times that the client software 30 started, stopped, paused, and resumed,
   ii. Time periods when the client system 24 was idle,
   iii. Time periods the client software 30 was operated in a manual mode (versus automatic mode), and
   iv. Times of actions, action processes, files involved, file locations, and process versions.
33. In some embodiments, the FTP client 78 sends time tracking data to the server system 12 of FIG. 1 via an FTP channel formed in the communication network 22 of FIG. 1. In some embodiments, the log file 32 is a “flat” text file, including lines of text separated by carriage returns. Each line of text represents a log entry, and each log entry includes time information and data regarding the user's activity or work effort at the instant the log entry was made. Times recorded in log entries are stored as numbers representing a number of seconds from 12:00:01 a.m. on Jan. 1, 1970, to a current time indicated by a time keeping system of the client system 24.
34. In some embodiments, the log file 32 of FIG. 1 is named ‘stats.ttb.’ An ‘accounts.ini’ file contains a list of names of accounts and subaccounts created by the user. When time tracking data is to be sent to the server system 12, the client software 24 uploads the ‘stats.ttb’ file and the ‘accounts.ini’ file to a folder residing in the memory 16 or storage of the server system 12. Before being uploaded, the ‘stats.ttb’ file is renamed ‘UserIDTimeStampstats.ttb,’ and the ‘accounts.ini’ file is renamed ‘UserIDTimeStampaccounts.ini.’
35. In some embodiments, the FTP client 78 sends time tracking data to the server system 12 either on demand, or as a scheduled task. For example, the user interface 74 may include computer instructions for creating a button on the display screen 58 of the display device 56 of FIG. 3. When the user activates the button, a process may be initiated in which the FTP client 78 uploads time tracking data to the server system 12. Activating the button may, for example, result in the opening of a dialog box. In the dialog box, the user may enter an FTP address of the server system 12, an FTP user name, and an FTP password. Alternatively, the FTP client 78 may be configured to upload the time tracking data to the server system 12 via a background thread each time: (i) an application program is executed, (ii) each time the user exits an application program, or (iii) at predetermined time intervals (e.g., every day, week, or month). If a transfer of time tracking data is not successful, a user interface of the client software 30 may display an error message.
36. In some embodiments, the client software 30 operates in an automatic mode, a manual mode, or a stealth mode. The automatic mode was described above. In the manual mode, the user may enter time tracking data for actions that the client software 30 can't track (e.g., telephone calls). In the stealth mode, the client software 30 is not visible to the user of the client system 24. The client software 30 records the actions of the user, and sends time tracking data to the server system 12 of FIG. 1 via the FTP client 78. The stealth mode may be used to gauge, for example, employee productivity, or to collect statistics for operations research.
37. In some embodiments, the first time the client software 30 is executed by the processor(s) 26 of the client system 24, the client software 30 creates a directory with the following configuration files:
   i. ‘accounts.ini’ file: Contains a list of names of accounts and subaccounts created by the user,
   ii. ‘config.ini’ file: Contains a list of different options (e.g., timeout parameter, FTP address, etc.) used by the user,
   iii. ‘mappings.ini’ file: Contains a list of the files/URLs linked to the accounts,
   iv. ‘stats.ttb’ file: The log file 32 of FIG. 1 that contains the lines of textual data collected every 5 seconds,
   v. ‘times.ttb’ file: Contains a list of the elapsed times for each activity or work effort for a number of days, and
   vi. ‘versions.ini’ file: Contains a list of the processes tracked by the client software 30 and the corresponding version numbers.
38. In some embodiments, when execution of the client software 30 is initiated by the processor(s) 26, a tray icon is added to the system tray. By clicking on the tray icon, the client software 30 user interface window is either displayed or brought to the foreground.
39. FIG. 5 is a diagram of one embodiment of the server software 18 of FIG. 1. In the embodiment of FIG. 5, the server software 18 includes an applet 80, the database 20 (see FIG. 1), and a chart library 74.
40. In the following description, components of the server software 18 will be described as carrying out activities directly for the sake of clarity. It will be understood that the components include instructions that, when executed by the processor(s) 14 of the server system 12, cause the processor(s) 14 to carry out the activities.
41. The database 20 stores information including user names, time tracking data corresponding to each user name, and information specifying when time tracking data was received. In some embodiments, the database 20 includes one or more tables, where each table has one or more rows (i.e., records) and one or more columns (i.e., fields).
42. In some embodiments, the database 20 is or includes a MySQL™ database formed using the MySQL™ database software, available under license or subscription from MySQL Inc., Cupertino, Calif. In this situation, the database 20 is accessed using Structured Query Language (SQL) computer instructions. The database 20 includes one or more tables, and a MySQL™ database installation wizard contains a script for creating the tables.
43. A MySQL™ database includes a MYSQL™ Connector/J, a native Java™ driver that converts JDBC (Java™ Database Connectivity) calls into the network protocol used by the MySQL™ database software. The MYSQL™ Connector/J is a Type IV JDBC driver and has a complete JDBC feature set that supports the capabilities of the MySQL™ database.
44. In some embodiments, the applet 80: (i) checks files received from the client system 24 (see FIG. 1), (ii) updates the database 20, and (iii) creates Web pages that include information for displaying time tracking reports. In some embodiments, the database 20 includes one or more tables, and the applet 80 accesses and modifies the tables in the database 20. In some embodiments, the applet 80 includes Java™ programming language instructions. In embodiments where the database 20 is or includes a MySQL™ database, the applet 80 may use the MySQL Connector/J to access the database 20.
45. In some embodiments, each time the FTP client 78 uploads time tracking data to the server system 12, a timestamp is appended to the data. The timestamp indicates the user's name, and the day and time the time tracking data was uploaded (i.e., updated in the database 20). The database 20 contains a table of users. Each row of the table of users corresponds to a different user. In each row of the table of users, one column is for the name of the corresponding user, and another column is for a timestamp indicating when the user's time tracking data was last updated in the database 20. The time tracking data corresponding to the timestamp is also stored in the database 20.
46. In some embodiments, the server system 12 is configured to generate reports on the fly. When the applet 80 is called upon to display time tracking data of a particular user, the applet 80 starts by searching data files stored on the server system 12 for a time tracking data file corresponding to the particular user. The applet 80 searches the stored data files in the order the data files were received, searching the most recently received data files first. When the applet 80 finds a time tracking data file corresponding to the particular user, the applet 80 checks the timestamp of the data file against the timestamp corresponding to the user in the database 20. If the timestamp of the data file matches the timestamp corresponding to the user in the database 20, the applet 80 reads the time tracking data from the database 20.
47. If the timestamp of the data file is newer than the timestamp corresponding to the user in the database 20, indicating that the data file contains more recent time tracking data, the applet 80 updates the database 20 with the timestamp of the data file, stores the time tracking data corresponding to the timestamp in the database 20, and reads the time tracking data from the database 20.
48. If the timestamp of the data file is older than the timestamp corresponding to the user in the database 20, indicating that the data stored in the database 20 contains more recent time tracking data, the applet 80 sends an error message to the administrator of the server system 12 indicating an apparent bug or missing data file, then reads the time tracking data from the database 20.
49. In some embodiments, the chart library 82 includes a collection of templates that may be filled with data from the database 20 to create reports. In some embodiments, the chart library 82 includes computer instructions forming Web page templates. The applet 80 reads templates form the chart library 82 and fills the templates with data from the database 20 to create Web pages including information used to display time tracking reports.
50. In some embodiments, the server software 18 includes Web server software, and the server system 12, running the server software 18, forms a Web server. The server system 12 has an Internet Protocol (IP) address and uses the Hypertext Transfer Protocol (HTTP) and the Transmission Control Protocol/Internet Protocol (TCP/IP) to deliver Web pages to the client system 24. Suitable Web server software includes the Apache Tomcat Web server software, available under license from the Apache Software Foundation (Los Angeles, Calif.). The Apache Tomcat Web server software is an implementation of the Java™ Servlet and Java™ Server Pages technologies.
51. In some embodiments, each registered user (e.g., subscriber or customer) has access to the server system 12, running the server software 18, in a service mode. A supervisor (i.e., administrator or account manager) in charge of one or more users can log in to the server system 12 and have access to a dashboard created by the server software 18. The dashboard is an image or page for display on a display screen, and contains a list of user names. When the supervisor selects a particular user from the list of user names, and a date range, the applet 80 displays a chart based on time tracking data corresponding to the particular user and stored in the database 20. Similarly, when the supervisor selects a group of users from the list of user names, and a date range, the applet 80 displays a chart based on time tracking data corresponding to the selected users and stored in the database 20. The applet 80 uses the chart library 74 to produce charts, and to interact with supervisor. Charting activities that can be performed using the applet 80 include drilling down, zooming, filtering, and printing.
52. As described above, in some embodiments, the activity log is an image or page including information for displaying a summary of user activities and the corresponding elapsed times. The activity log is created using data stored in the log file 32 of FIG. 1 (i.e., the ‘stats.ttb’ file). In some embodiments, the activity log also includes a bar chart and a pie chart illustrating elapsed times spent on each account.
53. In some embodiments, the activity log is generated by comparing successive lines of the log file 32 of FIG. 1 (i.e., the ‘stats.ttb’ file). For example, in comparing a first line and a successive second line of the log file 32, the timestamp of the second line minus the timestamp of the first line gives the elapsed time for the activity or work effort of the first line. All of the time spent on a given activity or work effort can then be accumulated into a single entry in the activity log. For example, if the user of the client system 24 of FIG. 1 worked on a Word® document ‘Doc1.doc’ between 10:00 a.m. and 11:00 a.m., and again from 4:00 p.m. to 4:30 p.m., there will be many corresponding lines in the log file 32 of FIG. 1 (i.e., the ‘stats.ttb’ file), but the activity log will show only one line:
54. “1h30mm Doc1.doc”
55. where the ‘1h30mm’ is the elapsed time, and the ‘Doc1.doc’ is the activity or work effort. It is noted that start, stop, and pause actions recorded in the log file 32 of FIG. 1 are not displayed in the activity log.
56. In some embodiments, information displayed in the activity log can be filtered using a calendar or a dropdown listing of the accounts. (See, for example, FIG. 7.) On a left side of the activity log there is a calendar and a tree menu. By selecting a date from the calendar, the activity log is updated to reflect data from the selected date.
57. In some embodiments, every user activity or work effort has a corresponding line in the activity log. Every activity or work effort is linked to either an account, or to ‘No Account’ (if the file, folder, or URL involved in the activity or work effort has not been linked to an account). It is thus possible to filter on the accounts.
58. As described above, activities or work efforts carried out by the user using the client system 24 of FIG. 1 can be linked to an account by the user. In some embodiments, the list of accounts and sub-accounts is represented by the tree menu. A node is an account or sub-account. When the user right clicks on a node and select “Filter on this account” or “Filter on this account and its sub-accounts,” the activity log is updated to show only data linked to the selected account.
59. In some embodiments, the user may exit a filtering mode by selecting the parent node (“All”), right clicking and selecting “Filter on this account,” or selecting “Filter on this account and its sub-accounts.”
60. In some embodiments, the information in the activity log can be viewed by accounts, activities, or process. The activity log page is an interactive document that responds to a mouse right click event. By right clicking inside the displayed image, a menu is displayed with the following items: ‘View by Account,’ ‘View by Action,’ and ‘View by Application.’
61. In some embodiments, the ‘View by Action’ is the default current view. When the ‘View by Action’ is the current view, the activity log includes lines of text, with each line of text including a name of the activity or work effort (e.g., browsing a URL, accessing a document, etc.) and the corresponding elapsed time. When the ‘View by Account’ is the current view, the activity log includes lines of text, with each line of text including the name of an account and a total of elapsed times attributed to the account.
62. In some embodiments, every activity or work effort is linked to a process name. For example, editing a Word® document is linked to the process ‘winword.exe,’ and Web browsing sessions using the Firefox Web browser are linked to the process ‘firefox.exe.’ When the ‘View by Application’ is the current view, the activity log includes lines of text, where each line of text includes a name of a process, a total of elapsed times attributed to the process, and the version of the process.
63. FIGS. 6A and 6B in combination form a flowchart of one embodiment of a method 90 for tracking a subject's use of time. The subject may be, for example, the user of the client system 24 of FIG. 1. During a first step 92 of the method 90, a link is established between a work effort and an account, thereby generating link data. The work effort may be or include, for example, a file, a folder, or a URL. The work effort may also be or include, for example, an email message, use of an application software program, or a telephone call. As described above, the file or folder may be stored on the client system 24 of FIG. 1, or on a computer system accessible by the client system 24 via the communication network 22 of FIG. 1. The URL may be the URL of a Web page. The step 92 may be, for example, carried out by the user of the client system 24 with the aid of the client software 30. As described above, the user interface 74 of the client software 30 allows the user to link specific activities to accounts (or subaccounts) via a drag-and-drop function. The user can also link documents to accounts (or subaccounts) via a directory navigation system in a manner similar to locating a document using Windows Explorer®. The user can link specific documents on the Web to accounts (or subaccounts) by assigning URLs of the documents to the account (e.g., via direct entry). The user can also link email addresses and phone numbers to accounts (or subaccounts) via direct entry. The link data may be stored in the ‘accounts.ini’ file described above. It is noted that the link data may associate multiple accounts with corresponding work efforts, and any given account may have multiple corresponding activities or work efforts.
64. At timed intervals, time tracking data indicative of a work effort that is currently active is recorded during a step 94. The client system 24 of FIG. 1, executing the client software 30, may automatically carry out the step 94 as the user of the client system 24 operates the client system 24. The time tracking data may be recorded in a log file (e.g., the log file 32 of FIG. 1) as described above. As described above, the recording may include querying an operating system of the client system 24 to obtain a title of a foreground window in which the user of the client system 24 is currently working. The recording may also include generating data indicative of a current time and the title of the foreground window, and storing the data in the log file. As described above, the log file 32 of FIG. 1 may be the ‘stats.ttb’ file.
65. During a step 96, the time tracking data and the link data is transmitted. The client system 24 of FIG. 1, executing the client software 30, may carry out the step 96, transmitting the time tracking data (stored in the log file 32) and the link data to the server system 12 of FIG. 1. As described above, the transmitting of the time tracking data and the link data may occur on demand, or as a scheduled task.
66. The time tracking data and the link data is transmitted during a step 98. The server system 12 of FIG. 1, executing the server software 18, may carry out the step 98, receiving the time tracking data and the link data from the client system 24 of FIG. 1. As described above, the time tracking data and the link data may be stored in the database 20 of FIG. 1.
67. During a step 100, the time tracking data and link data are analyzed, thereby attributing a portion of the subject's time to the account in the link file. A report is generated during a step 102 where the portion of the subject's time is attributed to the account. During a step 104, the report is transmitted (e.g., to the client system 24 of FIG. 1). The server system 12 of FIG. 1, executing the server software 18, may carry out the steps 100, 102, and 104.
68. The report is received during a step 106, and the report is displayed on a display screen during a step 108. The client system 24 of FIG. 1, executing the client software 30, may carry out the steps 106 and 108.
69. FIG. 7 is an image of an activity log page of an illustrative activity report as displayed on a display screen. As described above, in some embodiments the activity log is an image or page including information for displaying a summary of user activities and the corresponding elapsed times. When the server system 12 of FIG. 1 receives a request for an activity log from the client system 24, the server system 12 generates the activity log on the fly and transmits the activity log to the client system 24. The clients system 24 receives the activity log from the server system 12, and displays the activity log on the display screen 58 of the display device 56 of FIG. 3.
70. In some embodiments, the activity log page of FIG. 7 is the default activity log page, and includes a summary of user activities or work efforts for the current day sorted by elapsed time. The activity log page of FIG. 7 includes an ‘Elapsed Time’ column and an ‘Action’ column. As described above, every recorded activity or work effort of the user of the client system 24 of FIG. 1 is linked to either an account, or to ‘No Account’ (if the file, folder, or URL involved in the activity or work effort has not been linked to an account). Accounts linked to recorded activities or work efforts of the user are listed in the ‘Action’ column, and corresponding elapsed times are listed in the ‘Elapsed Time’ column. In the activity log page of FIG. 7, ‘00h 07m46s’ is attributed to ‘No Account,’ indicating the user spent 7 minutes and 46 seconds performing activities or work efforts not linked to an account. ‘00h 05m45s’ is attributed to ‘Email Reading,’ indicating that the user spent 5 minutes and 45 seconds performing activities or work efforts linked to an account entitled ‘Email Reading.’ ‘00h 05m10s’ is attributed to ‘TTB LLC Patent,’ indicating that the user spent 5 minutes and 10 seconds performing activities or work efforts linked to an account entitled ‘TTB LLC Patent.’ ‘00h 04m35s’ is attributed to ‘TTB Dev Look and Feel,’ indicating that the user spent 4 minutes and 35 seconds performing activities or work efforts linked to an account entitled ‘TTB Dev Look and Feel.’
71. FIG. 8 is an image of a bar chart page of an illustrative activity report as displayed on a display screen. The bar chart page of FIG. 8 includes a bar chart summary of user activity times for the current day. (Other periods of time may also be selected.) Horizontal bands represent accounts, and vertical heights of the bands are proportional to the total amounts of time (i.e., elapsed times) the user spent performing corresponding activities. In the bar chart page of FIG. 8, ‘0h 5m 45s’ is attributed to ‘Email Reading,’ indicating the user spent 5 minutes and 45 seconds performing activities or work efforts linked to an account entitled ‘Email Reading.’ ‘0h 5m 10s’ is attributed to ‘TTB LLC Patent,’ indicating that the user spent 5 minutes and 10 seconds performing activities or work efforts linked to an account entitled ‘TTB LLC Patent.’ ‘0h 4m 50s’ is attributed to ‘TTB Dev Look and Feel,’ indicating that the user spent 4 minutes and 50 seconds performing activities or work efforts linked to an account entitled ‘TTB Dev Look and Feel.’ ‘0h 8m 51’ is attributed to ‘No Account,’ indicating that the user spent 8 minutes and 51 seconds performing activities or work efforts not linked to an account.
72. FIG. 9 is an image of a pie chart page of an illustrative activity report as displayed on a display screen. The pie chart page of FIG. 9 includes a pie chart summary of user activity times for the current day. (Other periods of time may also be selected.) A circle is divided into sectors representing accounts, where angles and areas of the sectors are proportional to the total amounts of time (i.e., elapsed times) the user spent performing corresponding activities. In the pie chart page of FIG. 9, the circle includes a sector labeled ‘Email Reading,’ where an angle and area of the sector is proportional to the elapsed time the user spent performing activities or work efforts linked to the account entitled ‘Email Reading.’ The circle also has a sector labeled ‘TTB LLC Patent,’ where an angle and area of the sector is proportional to the elapsed time the user spent performing activities or work efforts linked to the account entitled ‘TTB LLC Patent.’ The circle also has a sector labeled ‘TTB Dev Look and Feel,’ where an angle and area of the sector is proportional to the elapsed time the user spent performing activities or work efforts linked to the account entitled ‘TTB Dev Look and Feel.’ The circle also has a sector labeled ‘No Account,’ where an angle and area of the sector is proportional to the elapsed time the user spent performing activities or work efforts not linked to an account.
73. Numerous variations and modifications will become apparent to those skilled in the art once the above disclosure is fully appreciated. It is intended that the following claims be interpreted to embrace all such variations and modifications.

What is claimed is:

1. A method for tracking a subject's use of time, comprising:
at timed intervals, recording time tracking data indicative of a work effort being accessed by the subject;
analyzing the time tracking data and link data to attribute a portion of the subject's time to an account, wherein the link data associates one or more accounts with corresponding work efforts; and
generating a report wherein the portion of the subject's time is attributed to the account.

2. The method as recited in claim 1, wherein the subject is a computer system user.

3. The method as recited in claim 1, wherein the work efforts each comprise a file, a folder, or a Universal Resource Locator.

4. The method as recited in claim 1, further comprising:
linking one or more accounts with corresponding work efforts to generate said link data.

5. The method as recited in claim 4, wherein said linking is carried out on a computer system using a drag-and-drop function.

6. The method as recited in claim 1, wherein the recording of the time tracking data comprises:
obtaining a handle of a foreground window from an operating system.

7. The method as recited in claim 1, wherein the recording of the time tracking data is performed on a first computer system, and wherein the method further comprises:
transmitting the time tracking data to a second computer system.

8. The method as recited in claim 7, wherein the analyzing and the generating are performed on the second computer system.

9. A method for tracking a subject's use of time, comprising:
establishing a link between at least one work effort and an account, thereby generating link data;
at timed intervals, recording time tracking data indicative of a work effort that is currently active on a computer system operated by the subject;
transmitting the time tracking data and the link data to a central server;
receiving from the central server a report that attributes a portion of the subject's time to the account; and
displaying the report.

10. The method as recited in claim 9, wherein the work effort is a file, a folder, or a Universal Resource Locator.

11. The method as recited in claim 9, wherein the establishing of the link between the work effort and the account is carried out on a computer system using a drag-and-drop function.

12. The method as recited in claim 11, wherein the time tracking data is recorded in a log file.

13. The method as recited in claim 12, wherein the recording comprises:
querying an operating system of the computer system to obtain a title of a foreground window in which the subject is currently working.

14. The method as recited in claim 13, wherein the recording further comprises:
generating data indicative of a current time and the title of the foreground window; and
storing the data in the log file.

15. A method for tracking a subject's use of time, comprising:
receiving time tracking data and link data, wherein the time tracking data is indicative of work efforts active at timed intervals on a computer system operated by the subject, and wherein the link data associates one or more accounts with corresponding work efforts;
analyzing the time tracking data and link data, thereby attributing a portion of the subject's time to at least one of the one or more accounts;
generating a report wherein the portion of the subject's time is attributed to the at least one of the one or more accounts; and
transmitting the report.

16. The method as recited in claim 15, wherein the subject is a computer system user.

17. The method as recited in claim 15, wherein the work efforts each comprise a file, a folder, or a Universal Resource Locator.

18. A computer system, comprising:
a display screen;
a memory containing instructions for:
establishing a link between a work effort and an account, thereby generating link data;
at timed intervals, recording time tracking data indicative of a work effort that is currently active on the computer system, wherein the computer system is operated by a user;
transmitting the time tracking data and the link data;
receiving a report wherein a portion of the user's time is attributed to the account;
displaying the report on the display screen; and
at least one processor coupled to the memory and configured to fetch the instructions from the memory and to execute the instructions.

19. The computer system as recited in claim 18, wherein the work efforts each comprise a file, a folder, or a Universal Resource Locator.

20. A computer system, comprising:
a memory containing instructions for:
receiving time tracking data and link data, wherein the time tracking data is indicative of work efforts accessed by a subject at timed intervals, and wherein the link data is indicative of a link established between a work effort and an account;
analyzing the time tracking data and link data, thereby attributing a portion of the subject's time to the account;
generating a report wherein the portion of the subject's time is attributed to the account;
transmitting the report; and
at least one processor coupled to the memory and configured to fetch the instructions from the memory and to execute the instructions.
